(19) United States
(12) Patent Application Publication
(10) Pub. No.: US 2007/0120358 A1
(43) Pub. Date: May 31, 2007

(54) Patient wristband form

(76) Inventors: Bryce C. Waggoner, Monroe, OH (US); Bobby W. Roach, Raleigh, NC (US); Scott J. Wilson, Raleigh, NC (US); David F. Laurash, Dayton, OH (US)

Correspondence Address: DINSMORE & SHOHL LLP;One Dayton Centre, Suite 1300, One South Main Street, Dayton, OH, 45402-2023, US

(21) Appl. No.: 11/291,069

(22) Filed: Nov. 30, 2005

(51) Int. Cl. B42D 15/00

(52) U.S. Cl. 283/81

(57) ABSTRACT

A form has detachable labels and one or more wristbands. The wristband includes detachable labels. The form has a printable face sheet with first and second major surfaces. A pressure sensitive adhesive is provided on at least a portion of one surface of the face sheet. The form includes a liner ply having first and second major surfaces, and a release coating on at least a portion of one surface thereof. The face sheet includes first and second adjacent portions, with the first portion of the face sheet being die cut to form one or more a detachable wristbands. The liner ply is adhered to the pressure sensitive adhesive on the first and second portions of the face sheet. The wristband or wristbands include a plurality of labels carrying a pressure sensitive adhesive. The labels are printed with information so that they can be removed from the wristband and applied to forms, containers, and the like.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to a printable form, and more particularly, to a form having a wristband that includes a plurality of detachable labels which may be printed with information in a single pass through a printer. The form may also include an additional plurality of labels which are printed at the same time. Other parts of the form may also be printed at the same time.

It is a common practice in hospitals to identify each patent with a bracelet or band bearing the patient's name or other identification information. The band is generally secured around the wrist of the patient so that hospital personnel can properly identify the patient whether or not the patient is conscious. Although this has been an effective method of identifying patients, many hospitals have had problems correlating patient information on specimens, drug prescriptions, physician's orders, etc. Clerical errors in the handling of such routine matters can result in dispensing the wrong medicine to a patient, or otherwise producing errors in patient treatment.

Several approaches have been taken to improve the correlation of patient information to various hospital forms. For example, Falla U.S. Pat. No. 4,122,947 teaches a pre-packaged patient identification kit which includes a wristband, a specimen container, and a label for attachment to a patient's record, all of which have been provided with identical patient information. Weichselbaum et el U.S. Pat. No. 3,848,112, teaches a patient identification system in which an identification bracelet secured to a patient is used to dispense a series of tags which are magnetically coded with patient information. However, this requires the use of a tag reader as well as circuitry which is capable of decoding the information on the tag.

Huddleston U.S. Pat. No. 5,653,472, discloses an improvement over such systems. In the preferred embodiment of this patent, a form having a face ply adhered to a liner ply by a pressure sensitive adhesive includes both a plurality of labels bearing patient specific identification information and a wristband having patient specific identification information. The form is printed in one pass. The wristband is applied to the patient and the balance of the form is kept with the patient's chart. The labels are removed from the form and used, as required, to label various items, e.g. blood samples, as belonging to or being associated with the patient in some manner. The drawback here, however, is that the form bearing the labels may be removed from the patient's chart and may then become disassociated with the patent.

Schintz U.S. Pat. No. 6,641,048 discloses another wristband form. In the wristband disclosed in this patent, the elongate strip making up the wristband includes adhesive contact portions and one or more laterally placed adhesive winged detents. The winged detents can be folded over one or more parts of the elongate strip to provide enhanced durability. In one configuration, a multi-ply sheet is defined by an elongate strip formable into a wristband and an array of labels. The labels are die cut into a first ply adhesively removable from a second ply. The sheet can be either an individual cut sheet, part of a continuous fan-folded form or part of a larger continuous roll. The form can be fed into a conventional automated printer to facilitate the placing of printed indicia on the wristband and labels.

In Chadwick U.S. Published App. 20040237366, filed May 28, 2004, a further patient wristband and form is disclosed. In the Chadwick application, an identification bracelet for use in a hospital is made of a strip of material that is resistant to common solvents and that has adhesive on a single end of the side of the strip opposite the printed side. The bracelet may be made from material that is printable by an office laser printer or from material that is printable by an ink jet printer that uses water-soluble inks. In the latter case, the material permits high-resolution printing and renders the printing resistant to wear and to common solvents.

Accordingly, there is a need in the art for an identification system which includes a wristband as well as an accompanying series of labels or tags which can be efficiently provided with correlating identification information, and which can be easily dispensed and used for a variety of applications.

### SUMMARY OF THE INVENTION

The present invention meets those needs by providing a form which includes one or more wristbands as well as a series of detachable labels that are carried by the wristband or wristbands. The form is printed in a single pass through a printer to provide unique patient identification information on both the wristband or wristbands and on one or more of the labels. The wristbands may be peeled away from the form and attached to the patient's wrist. The labels are removed from the wristbands as needed and applied to hospital forms, containers of medicine, and the like. The form may be printed using a variety of printers, including mechanical impact printers, direct thermal printers, thermal transfer printers, ink jet printers, and laser printers.

In accordance with one embodiment of the invention, a form having one or more detachable labels and a wristband comprises a printable face sheet having first and second major surfaces and having a pressure sensitive adhesive on at least a portion of one surface thereof. The face sheet includes first and second adjacent portions. The first portion of the face sheet is die cut to form a detachable wristband having first and second ends and first and second sides. The wristband is die cut to form one or more labels carrying a pressure sensitive adhesive which may be removed from the balance of the wristband. The second portion of the face sheet may be die cut to form a series of detachable labels.

The form also includes a liner ply having first and second major surfaces. The liner ply includes a release coating on at least a portion of one surface and is adhered to the pressure sensitive adhesive on the first or second surface of the face ply. Preferably, the liner ply is coextensive with the face ply. The first portion of the face sheet may comprise a top ply having an upper surface and a lower surface, and a pressure sensitive adhesive on the lower surface of the top ply. A lower ply has an upper surface and a lower surface, with the upper surface of the lower ply having a release coating thereon. The first major surface of the face sheet includes printed indicia thereon. The printed indicia are patient specific, and are printed on the plurality of labels on the wristband and on the detachable labels on the second portion of the printable face sheet.

In a preferred embodiment of the invention, the first and second portions of the face sheet are separated and may comprise different materials. For example, the first portion of the face sheet may comprise a polymer such as polyester and the second portion of the face sheet may comprise paper. In an alternative embodiment, the entire face sheet may comprise a single type of material, such as paper or a polymer.

In another embodiment of the invention, the form includes a printable face sheet having first and second major surfaces and having a pressure sensitive adhesive on at least a portion of one surface thereof. The face sheet is die cut to form a detachable wristband having first and second ends and first and second sides. The wristband includes a plurality of labels carrying a pressure sensitive adhesive which may be removed from the balance of the wristband. The form further includes a liner ply having first and second major surfaces. The liner ply includes a release coating on at least a portion of one surface thereof and is adhered to the pressure sensitive adhesive on the first and second portions of the face sheet.

In another embodiment of the invention, the form includes a face sheet which is die cut to form a plurality of detachable wristbands, with at least one of the wristbands being die cut to form one or more labels carrying a pressure sensitive adhesive, and with at least one or more of the wristbands having no labels. The face sheet may be die cut to provide an additional series of detachable labels.

In yet another embodiment, a form has a plurality of detachable wristbands. The form includes a printable face sheet which is die cut to form the wristbands. At least one of the wristbands is die cut to form a plurality of labels carrying a pressure sensitive adhesive. At least one of the wristbands has no labels. A liner ply includes a release coating on at least a portion of one surface.

In yet another embodiment, a printable face sheet is die cut to form a detachable wristband. The wristband is die cut to form one or more labels carrying a pressure sensitive adhesive. A liner ply includes a release coating on at least a portion of one surface thereof. The liner ply is adhered to the pressure sensitive adhesive on the face sheet. The liner ply is die cut to form a portion of the detachable wristband beneath the labels.

Accordingly, it is a feature of the present invention to provide a form having detachable labels and a wristband that may be easily provided with information by printing in a single pass through a printer. This and other features and advantages of the present invention will become apparent from the following detailed description, the accompanying drawings, and the appended claims.

### BRIEF DESCRIPTION OF THE DRAWINGS

FIG. 1 is a top view of the form of the present invention;

FIG. 2 is a cross-sectional side view of the form, taken along line 2-2 in FIG. 1;

FIG. 3 is a bottom view of the top sheet of the form, taken generally along line 3-3 in FIG. 2;

FIG. 4 is a top view of another form of the present invention, incorporating a plurality of wristbands.

FIG. 5 is a top view of another form of the present invention, incorporating a two ply construction; and

FIG. 6 is a cross-sectional side view of the form, taken generally along line 6-6 in FIG. 5.

### DETAILED DESCRIPTION OF THE PREFERRED EMBODIMENT

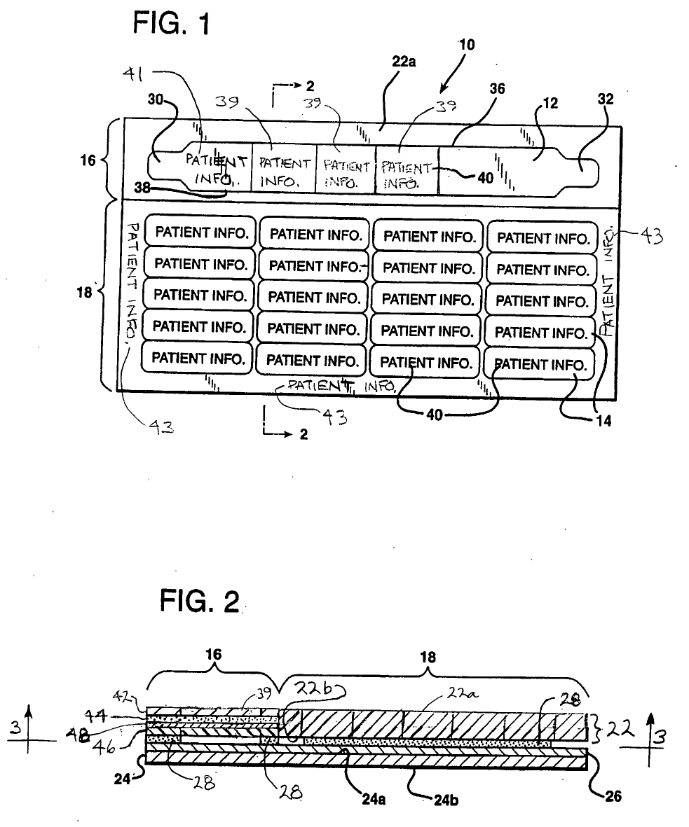

Referring now to FIGS. 1, 2 and 3, the form 10, constructed according to the present invention, includes a wristband 12 having first and second ends 30, 32 and first and second sides 36, 38. The form also includes a series of detachable labels 14. The form is separated into a first portion 16, which contains the wristband 12, and a second portion 18, which contains the labels 14. As described more fully below, the wristband 12 is die cut to form a plurality of labels 39. Labels 14 and 39 all carry adhesive coatings.

The first and second portions 16 and 18 of the form 10 are printed with correlating printed indicia 40, indicated as patient information. By correlating indicia, it is meant that information printed on the first portion 16 is the same as, or in some way is related to, the information printed on the second portion 18. For example, the first and second portions may be printed with various information relating to a specific patient, or with the same information. In either event, however, all of the information relates to the same patient.

As shown in FIG. 2, the form 10 comprises a printable face sheet 22 having a first major surface 22a and a second major surface 22b and a liner ply 24 having a first major surface 24a and a second major surface 24b. In this embodiment, the face sheet 22 in the first portion 16 is comprised of a different material than the face sheet 22 in the second portion 18. The face sheet in portion 18 may preferably be comprised of paper. The face sheet 22 in portion 16 is of a somewhat more complicated in construction. The first portion 16 of the face sheet 22 comprises a top polymer ply 42 having an upper surface and a lower surface, a pressure sensitive adhesive 44 on the lower surface of the top polymer ply 42, and a lower polymer ply 46 having an upper surface and a lower surface. The upper surface of the lower polymer ply 46 carries a release coating 48. Although both plies 42 and 46 in this embodiment are preferably a polymer sheet material, other embodiments may use paper plies or plies of other suitable materials. Further, the upper and lower plies may be made of the same material, or of differing materials.

As shown in FIG. 2, the face sheet 22 is adhered to the liner ply 24 by a pressure sensitive adhesive 28 included on a portion of the second surface 22b of the face sheet 22. The liner ply 24 includes a release coating 26 on one surface to allow the portions of the face sheet 22 to be peeled away from the liner ply 24.

As will be noted, the face sheet 22 includes printed indicia 40 thereon, the printed indicia being patient specific and printed on the plurality of labels 39 on the wristband 12 and on the detachable labels 14 on the second portion 18 of the printable face sheet. 22. The printed indicia may also appear on the wristband 12, as at 41, and on the top sheet 22, as at 43, in areas that are not part of the labels 14 and 39. Further, if desired, the printed indicia may also appear on other parts of the face form 10. Other printed matter, unrelated to the patient information, may also appear on the form 10.

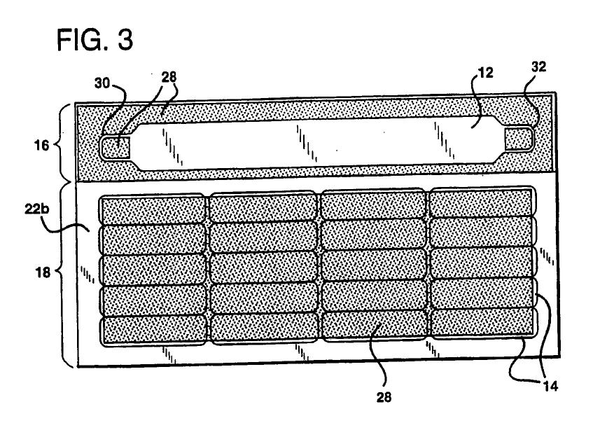

FIG. 3 shows portions of the second surface 22b of the face sheet which include pressure sensitive adhesive 28. As illustrated in this figure, the pressure sensitive adhesive 28 is included in first portion 16 around the periphery of wristband 12, and preferably on the first and second ends 30, 32 of the wristband. As may be apparent, however, adhesive 28 may be included on only one of the ends 30, 32, if desired. In second portion 18, the pressure sensitive adhesive is included in the area containing the detachable labels 14. The pressure sensitive adhesive may be full coated or pattern coated as desired. For example, the pressure sensitive adhesive may be pattern coated on the form in a striped pattern. A plurality of labels 14 are shown on the second portion 18. It will be appreciated, however, that only a single such label may be provided, if desired. Similarly, a series of labels 39 are shown on the wristband 12, but only a single label may be provided if the particular application calls for such a construction.

In addition to the arrangement shown, it should be appreciated that the pressure sensitive adhesive may be included in a number of other arrangements and patterns on the second surface of the face sheet 22, as required by the application. It should also be appreciated that the arrangement of the labels and the wristband or wristbands on the form may be varied. For example, the form may contain labels of different sizes, it may contain more than one wristband, and it may contain a different number of labels. In the event that the form includes multiple wristbands, some of those wristbands may carry labels, while others do not. All of the wristbands have patient information, however, that relate to the specific patient.

The form of the present invention may be produced as a continuous web product, or as a sheet product (as shown in FIG. 1). In either configuration, the form is capable of being fed through a printer and printed in a single pass to add indicia 40 simultaneously on the wristband or wristbands, and on some or all of the labels 14 and 39. The printed indicia may include both non-variable information (i. e., information which does not change from label to label) such as the hospital name, and variable information (i. e., information which is unique or specific to an individual and which changes from label to label) such as the patient's name and identification number. The face sheet 22 may be printed using a number of different automated printing devices including impact printers, ion deposition printers, ink jet printers, laser printers, direct thermal printers, and thermal transfer printers. If direct thermal printing is used, an imaging coating must be provided on the face sheet of the form.

In use, the wristband is peeled away from the liner ply and secured around the patient's wrist by the pressure sensitive adhesive on the ends of the wristband 10. The balance of the form 10 is attached to the patient's chart and accompanies the patient. The labels 14 on the form may be removed, as needed, and adhered to containers of medicine, doctor's orders, patient specimens, or other forms by means of the pressure sensitive adhesive on the second surface of the face sheet. Further, in the event that the form 10 is unavailable, one of the labels 39 may be removed from the wristband 12, and applied to the sample bottle, medicine bottle, specific patient form, or used in some other fashion.

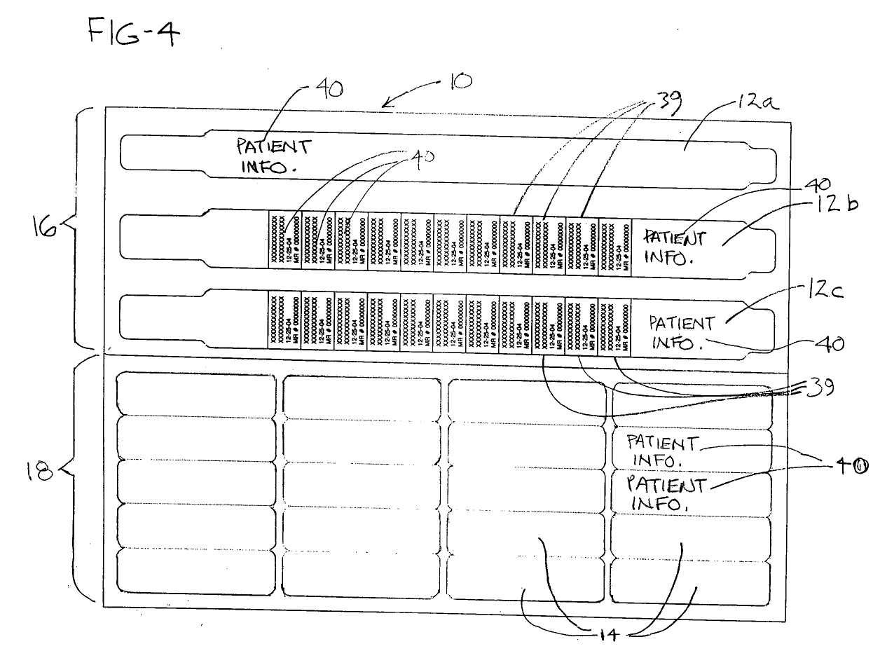

Reference is made to FIG. 4 which illustrates another embodiment according to the present invention. The form of FIG. 4 is similar to that of FIGS. 1-3, with the exception that it includes three wristbands, designated 12a, 12b and 12c, rather than a single wristband. The form is separated into a first portion 16 that contains the wristbands 12a, 12b and 12c, and a second portion 18 that contains the labels 14. The wristbands 12b and 12c are constructed in the same manner as wristband 12 in FIG. 1. Wristbands 12b and 12c include labels 39, each of which includes patient information 40. Wristbands 12b and 12c may also include patient information which is not printed on one of the labels 39. Wristband 12a includes no labels, but does bear patient information 40 which may be the same as or more extensive than the patient information included on wristbands 12b and 12c and labels 14. In use, typically all three wristbands are applied to the patient's wrist, permitting access to a greater number of labels 39, and also allowing more patient information or additional patient information to be included on wristband 12a. It will be appreciated that any number of wristbands may be provided in the form, with one or more of the wristbands including labels 39, and one or more of the wristbands not including labels.

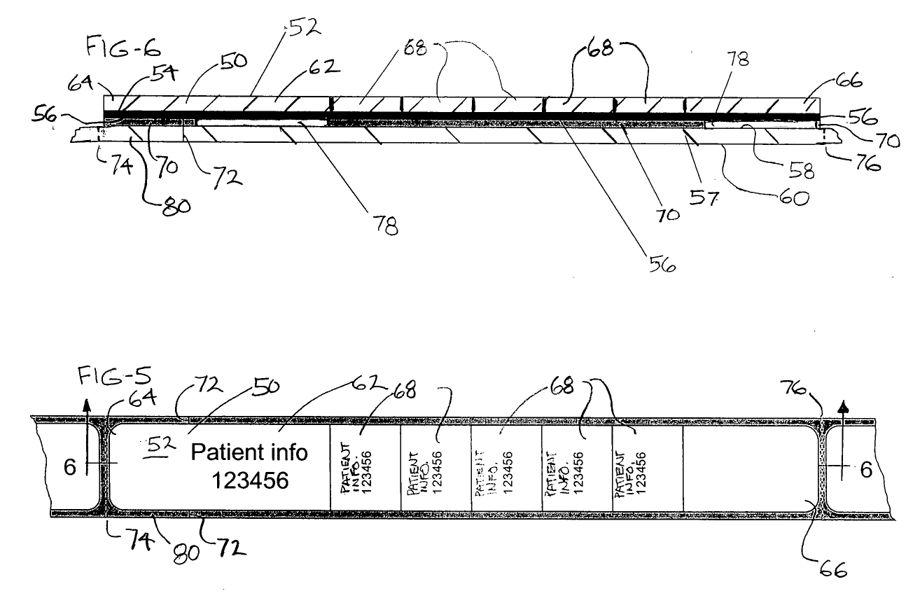

Reference is made to FIGS. 5 and 6 which illustrate another embodiment of the present invention. In this embodiment, a printable face sheet 50 has first and second major surfaces 52 and 54 and a pressure sensitive adhesive 56 on at least a portion of one surface. The wristband form has a liner 57 of paper or polymer material with first and second major surfaces 58 and 60. The face sheet 50 is die cut to form a detachable wristband 62 having first and second ends 64 and 66. The wristband 62 is die cut to form one or more labels 68 carrying a pressure sensitive adhesive 56. The labels 56 may be removed from the balance of the wristband 62. The liner 57 includes a release coating 70 on at least a portion of one surface 58 which is adhered to the pressure sensitive adhesive 56 on the face sheet 50. The liner 57 is die cut at 72 and perforated at 74 and 76 so that it can form a portion of the detachable wristband beneath one or more of the labels 68. The release coating 70 may not cover the entire surface 58 of the liner 57. Areas 78, for example, may be left without the release coating such that the face sheet 50 securely engages the liner 57.

In use, after the wristband is printed in a single pass through a laser printer, ink jet printer, impact printer, thermal printer, or other known printer. The form, which is illustrated as a continuous form although it may also be used as a sheet form, is then separated at perforation lines 74 and 76. The liner portion 80 is then removed, revealing adhesive 70 therebeneath. The wristband may then be wrapped around the patient's wrist and be secured in place as the exposed adhesive 70 is brought into contact with the top surface 52 of the wristband at end 66. As described previously with respect to the other embodiments, the labels 68 may then be peeled from the wristband and attached to forms and specimen containers, as needed, to identify them as associated with the patient wearing the wristband.

While certain representative embodiments and details have been shown for purposes of illustrating the invention, it will be apparent to those skilled in the art that various changes in the methods and apparatus disclosed herein may be made without departing from the scope of the invention, which is defined in the appended claims.

What is claimed is:

1. A form having detachable labels and a wristband comprising:
a printable face sheet having first and second major surfaces and having a pressure sensitive adhesive on at least a portion of one surface thereof, said face sheet including first and second adjacent portions, where said first portion of said face sheet is die cut to form a detachable wristband having first and second ends and first and second sides, where said wristband is die cut to form one or more of labels carrying a pressure sensitive adhesive which may be removed from the balance of said wristband, and where said second portion of said face sheet is die cut to form one or more of detachable labels; and
a liner ply having first and second major surfaces, said liner ply including a release coating on at least a portion of one surface thereof and being adhered to said pressure sensitive adhesive on said first and second portions of said face sheet.

2. The form of claim 1 wherein said first and second portions of said face sheet are separate sheets made of different materials.

3. The form of claim 2 wherein said first portion of said face sheet comprises a top polymer ply having an upper surface and a lower surface, a pressure sensitive adhesive on said lower surface of said top polymer ply, a lower polymer ply having an upper surface and a lower surface, said upper surface of said lower polymer ply having a release coating thereon, and wherein said second portion of said face sheet comprises a paper ply.

4. The form of claim 1 wherein said first portion of said face sheet comprises a top ply having an upper surface and a lower surface, a pressure sensitive adhesive on said lower surface of said top ply, a lower ply having an upper surface and a lower surface, and said upper surface of said lower ply having a release coating thereon.

5. The form of claim 1 wherein said face sheet comprises polyester.

6. The form of claim 1 wherein said first major surface of said face sheet includes printed indicia thereon, said printed indicia being patient specific and printed on said one or more labels on said wristband, and on said one or more detachable labels on said second portion of said printable face sheet.

7. The form of claim 1 wherein said liner ply is coextensive with said face sheet.

8. The form of claim 2 wherein said liner ply comprises first and second portions.

9. The form of claim 1 wherein said second surface of said first portion of said face sheet includes said pressure sensitive adhesive on said first and second ends of said wristband.

10. The form of claim 1 wherein said second surface of said second portion of said face sheet includes a pressure sensitive adhesive in the area containing said one or more detachable labels.

11. The form of claim 1 in which said form comprises a continuous web of forms defined by lines of weakness.

12. The form of claim 11 wherein said web is folded zig-zag into a stack.

13. A form having detachable labels and a wristband comprising:
a printable face sheet having first and second major surfaces and having a pressure sensitive adhesive on at least a portion of one surface thereof, said face sheet including first and second adjacent portions, where said first portion of said face sheet is die cut to form a detachable wristband having first and second ends and first and second sides, where said wristband includes one or more labels carrying a pressure sensitive adhesive which may be removed from the balance of said wristband, and where said second portion of said face sheet is die cut to form one or more detachable labels; and
a liner ply having first and second major surfaces, said liner ply including a release coating on at least a portion of one surface thereof and being adhered to said pressure sensitive adhesive on said first and second portions of said face sheet.

14. The form of claim 13 wherein said first and second portions of said face sheet are separate sheets made of different materials.

15. A form having detachable labels and wristbands comprising:
a printable face sheet having first and second major surfaces and having a pressure sensitive adhesive on at least a portion of one surface thereof, said face sheet including first and second adjacent portions, where said first portion of said face sheet is die cut to form a plurality of detachable wristbands having first and second ends and first and second sides, where at least one of said plurality of wristbands is die cut to form one or more labels carrying a pressure sensitive adhesive which may be removed from the balance of said wristband, and where said second portion of said face sheet is die cut to form one or more detachable labels; and
a liner ply having first and second major surfaces, said liner ply including a release coating on at least a portion of one surface thereof and being adhered to said pressure sensitive adhesive on said first and second portions of said face sheet.

16. The form of claim 15 wherein said first and second portions of said face sheet are separate sheets made of different materials.

17. A form having detachable labels and a wristband comprising:
a printable face sheet having first and second major surfaces and having a pressure sensitive adhesive on at least a portion of one surface thereof, where said face sheet is die cut to form a detachable wristband having first and second ends and first and second sides, and where said wristband is die cut to form one or more labels carrying a pressure sensitive adhesive which may be removed from the balance of said wristband; and
a liner ply having first and second major surfaces, said liner ply including a release coating on at least a portion of one surface thereof and being adhered to said pressure sensitive adhesive on said first and second portions of said face sheet.

18. The form of claim 17 wherein said face sheet includes first and second portions that are made of differing materials.

19. The form of claim 18 wherein said first portion of said face sheet comprises a top polymer ply having an upper surface and a lower surface, a pressure sensitive adhesive on said lower surface of said top polymer ply, a lower polymer ply having an upper surface and a lower surface, said upper surface of said lower polymer ply having a release coating thereon, and wherein said second portion of said face sheet comprises a paper ply.

20. The form of claim 17 wherein said face sheet comprises a top ply having an upper surface and a lower surface, a pressure sensitive adhesive on said lower surface of said top ply, a lower ply having an upper surface and a lower surface, and said upper surface of said lower ply having a release coating thereon.

21. The form of claim 20 wherein said top ply and said lower ply comprise a polymer material.

22. The form of claim 17 wherein said face sheet comprises polyester.

23. The form of claim 17 wherein said first major surface of said face sheet includes printed indicia thereon, said printed indicia being patient specific and printed on one or more of said one or more labels on said wristband.

24. The form of claim 17 wherein said liner ply is coextensive with said face sheet.

25. The form of claim 17 wherein said liner ply comprises first and second portions.

26. The form of claim 18 wherein said second surface of said first portion of said face sheet includes said pressure sensitive adhesive on said first and second ends of said wristband.

27. The form of claim 18 wherein said second surface of said second portion of said face sheet includes a pressure sensitive adhesive an area defining one or more detachable labels.

28. The form of claim 17 in which said form comprises a continuous web of forms defined by lines of weakness.

29. The form of claim 28 wherein said web is folded zig-zag into a stack.

30. A form having detachable labels and a wristband comprising:
a printable face sheet having first and second major surfaces and having a pressure sensitive adhesive on at least a portion of one surface thereof, where said face sheet is die cut to form a detachable wristband having first and second ends and first and second sides, where said wristband includes one or more labels carrying a pressure sensitive adhesive which may be removed from the balance of said wristband; and
a liner ply having first and second major surfaces, said liner ply including a release coating on at least a portion of one surface thereof and being adhered to said pressure sensitive adhesive on said first and second portions of said face sheet.

31. The form of claim 30 wherein said face sheet has first and second portions that are separate sheets made of differing materials.

32. A wristband form comprising:
a printable face sheet having first and second major surfaces and having a pressure sensitive adhesive on at least a portion of one surface thereof, said face sheet being die cut to form a detachable wristband having first and second ends, where said wristband is die cut to form one or more labels carrying a pressure sensitive adhesive which may be removed from the balance of said wristband; and
a liner ply having first and second major surfaces, said liner ply including a release coating on at least a portion of one surface thereof and being adhered to said pressure sensitive adhesive on said face sheet, said liner ply being die cut to form a portion of said detachable wristband beneath said one or more labels.

33. The form of claim 32 wherein said face sheet comprises a polymer ply.

34. The form of claim 32 wherein said face sheet comprises polyester.

35. The form of claim 32 wherein said first major surface of said face sheet includes printed indicia thereon, said printed indicia being patient specific and printed on said one or more labels on said wristband.

36. The form of claim 32 wherein said second surface of said face sheet includes pressure sensitive adhesive on said first and second ends of said wristband.

37. The form of claim 32 wherein said second surface of said face sheet includes pressure sensitive adhesive on one of said first and second ends of said wristband.

38. A form having a plurality of wristbands, comprising:
a printable face sheet having first and second major surfaces and having a pressure sensitive adhesive on at least a portion of one surface thereof, said face sheet including first and second adjacent portions, where said first portion of said face sheet is die cut to form a plurality of detachable wristbands having first and second ends and first and second sides, where one or more of said wristbands include a plurality of labels carrying a pressure sensitive adhesive which may be removed from said wristbands, where one or more of said wristbands include no labels, and where said second portion of said face sheet being die cut to form a series of detachable labels; and
a liner ply having first and second major surfaces, said liner ply including a release coating on at least a portion of one surface thereof and being adhered to said pressure sensitive adhesive on said first and second portions of said face sheet.

39. The form of claim 38 wherein said first and second portions of said face sheet are separate sheets made of different materials.

40. A form having detachable wristbands, comprising:
a printable face sheet having first and second major surfaces and having a pressure sensitive adhesive on at least a portion of one surface thereof, where said face sheet is die cut to form a plurality of detachable wristbands having first and second ends and first and second sides, where at least one of said plurality of wristbands is die cut to form a plurality of labels carrying a pressure sensitive adhesive which may be removed from the balance of said wristband, and where at least one of said plurality of wristbands has no labels; and
a liner ply including a release coating on at least a portion of one surface thereof and being adhered to said pressure sensitive adhesive on said face sheet.

41. The form of claim 40 wherein said face sheet has first and second portions made of different materials.

42. A method of using a form having detachable labels and a wristband, the form further having a printable face sheet with first and second major surfaces and having a pressure sensitive adhesive on at least a portion of one surface thereof, where said face sheet is die cut to form a detachable wristband having first and second ends and first and second sides, and where said wristband includes one or more labels carrying a pressure sensitive adhesive which may be removed from the balance of said wristband, and the form further including a liner ply having first and second major surfaces, said liner ply including a release coating on at least a portion of one surface thereof and being adhered to said pressure sensitive adhesive on said first and second portions of said face sheet, comprising the step of:
printing patient specific information on said wristband and on one or more of said labels in one printing pass.

43. The method of using a form having detachable labels and a wristband according to claim 42, comprising the further step of printing patient specific information on said printable face sheet during said one printing pass.

44. A method of using a wristband having a printable face sheet having first and second major surfaces and having a pressure sensitive adhesive on at least a portion of one surface thereof, said face sheet comprising a detachable wristband having first and second ends, where said wristband comprises one or more labels carrying a pressure sensitive adhesive which may be removed from the balance of said wristband, and a liner ply having first and second major surfaces, said liner ply including a release coating on at least a portion of one surface thereof and being adhered to said pressure sensitive adhesive on said face sheet, said liner ply being die cut to form a portion of
said detachable wristband beneath said one or more labels, comprising the step of printing patient specific information on said wristband and on one or more of said labels in one printing pass.
